(19) United States
(12) Patent Application Publication
(10) Pub. No.: US 2025/0002726 A1
(43) Pub. Date: Jan. 2, 2025

(54) DISPERSION-STABILISED MINERAL SUSPENSION

(71) Applicant: COATEX, Genay (FR)

(72) Inventors: Christian JACQUEMET, Lyon (FR); Benoit MAGNY, Fontaines Saint Martin (FR); Jacques MONGOIN, Quincieux (FR); Laurie PARRENIN, Villeneuve (FR); Jean-Marc SUAU, Lucenay (FR); Morgane LE NEINDRE, Curis-au-Mont-d’Or (FR)

(73) Assignee: COATEX, Genay (FR)

(21) Appl. No.: 18/709,676

(22) PCT Filed: Nov. 24, 2022
(86) PCT No.: PCT/FR2022/000120

§ 371 Date: May 13, 2024

(30) Foreign Application Priority Data
Nov. 25, 2021 (FR) FR2112481

(51) Int. Cl. C09C 3/10; C09C 3/04; D21H 17/00; D21H 19/56

(52) U.S. Cl. CPC C09C 3/10; C09C 3/041; D21H 17/74; D21H 19/56; C01P 2004/61; C01P 2006/22

(57) ABSTRACT

Provided is an aqueous suspension of a mineral material prepared using an improved aqueous dispersion of a (meth)acrylic polymer neutralized with a monovalent ion. Also provided is a dispersant including the aqueous suspension of a mineral material and methods for the preparation of a mass filler for the production of paper using the aqueous suspension of a mineral material, the preparation of a paper coating slip aqueous suspension of a mineral material, and the preparation of a coating composition aqueous suspension of a mineral material.

The invention provides an aqueous suspension of a mineral material, for example calcium carbonate, which is prepared by means of an aqueous dispersion of (meth)acrylic polymer neutralised by means of a monovalent ion. The invention also relates to a dispersing agent as well as to the use of this mineral suspension to prepare a mass filler for the preparation of paper or for its use in the preparation of a paper coating colour or in the preparation of a coating composition.

There are known methods for preparing suspensions of mineral material. In particular, there are known methods that use dispersing agents or grinding aid agents, in particular to control the rheology of the suspension when preparing or storing it.

Document WO 2007077484 describes the preparation, in the presence of a polyacrylate, of an aqueous suspension comprising ground calcium carbonate and precipitated calcium carbonate. Document WO 2008010055 describes the dispersion in water of a mineral material in the presence of a (meth)acrylic-maleic copolymer.

Generally speaking, the methods used to disperse or grind mineral materials must be effective and enable the particle size distribution of the resulting particles to be controlled. Furthermore, the methods for grinding mineral material must have a high efficacy in terms of grinding time for a particular particle size distribution for a defined amount of mineral material. In fact, when preparing a defined amount of mineral particles of a particular particle size distribution, reducing the operating time of the grinding equipment improves the overall yield of the grinding method.

Likewise, it is important to have methods for dispersing or grinding mineral materials that make it possible to prepare aqueous suspensions of particles of mineral material that are stable not only shortly after preparation, but also several hours or days later. Viscosity drift phenomena must be controlled because they can lead to gelation of the prepared suspensions which would make handling difficult or impossible. Likewise, particle settling phenomena must be avoided or substantially slowed.

In addition to controlling stability, it is also essential to control the viscosity of aqueous suspensions of dispersed or ground particles of mineral material.

It is also important to be able to prepare aqueous suspensions of particles of mineral material with a high solids content. A high solids content of these aqueous suspensions of particles of mineral material makes it possible in particular to increase the productivity of the methods that use these suspensions.

Moreover, it should be possible to prepare dispersing agents or grinding aid agents in the absence of any compounds that could be considered harmful from an environmental standpoint or in the absence of any compounds that are restricted for use by regulatory provisions. In particular, preparing these agents in the absence of any compound comprising phosphorus should be preferred, especially the absence of any phosphorus in oxidation state I, III or V. Furthermore, during papermaking, aqueous mineral filler compositions are used to provide a mineral filler within the pulp comprising water and fibres of vegetable origin, in particular fibres of cellulosic material. Within these compositions, the mineral filler is in the form of particles. The use of such mineral fillers makes it possible in particular to improve the physical properties of the paper, in particular to improve its optical properties, or to reduce the relative amount of cellulosic material in relation to the amount of mineral filler. Improving the efficacy of papermaking methods is also made possible through the use of these mineral fillers. The formation of flocs of mineral filler particles or of fibres that impair the quality of the paper must also be limited. Improving the compatibility of the various compounds used in the preparation of paper should also be sought.

Thus, although there are methods for dispersing or wet-grinding mineral materials using polymers as dispersing agent or as grinding aid agents, the methods in the prior art do not always make it possible to provide a satisfactory solution to the problems encountered with the aqueous mineral suspensions obtained. There is therefore a need for improved aqueous suspensions of mineral material. The invention makes it possible to provide a solution to all or part of the problems of the suspensions in the prior art.

Thus, the invention provides an aqueous suspension S of mineral particles prepared by dispersing in water at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV (sulphur IV or S IV), and completely or partially neutralised solely by means of at least one monovalent ion,
b) at least one compound B chosen among a sulpho-carboxylic acid, a sulpho-carboxylic acid salt and combinations thereof, present in a molar amount of less than 25% relative to the molar amount of sulphur IV.

Preferably for suspension S according to the invention, the particles of dispersed material M have a size of less than 50 μm or a size ranging from 0.05 to 50 μm or a size of less than 10 μm, preferably less than 5 μm or less than 2 μm, more preferentially less than 1 μm or less than 0.5 μm. Also preferably for suspension S according to the invention, material M is wet-ground in the presence of the aqueous dispersion. Preferably, the particles of ground material M thus have a size of less than 50 μm or a size ranging from 0.05 to 50 μm or a size of less than 10 μm, preferably less than 5 μm or less than 2 μm, more preferentially less than 1 μm or less than 0.5 μm.

Preferably according to the invention, the Brookfield viscosity of suspension S, measured after preparation at 100 rpm and at 25° C., is less than 1,000 mPa·s, preferably less than 800 mPa·s, more preferentially less than 500 mPa·s or less than 400 mPa·s.

Also preferably according to the invention, the Brookfield viscosity of suspension S, measured at 100 rpm and at 25° C. after being left to rest for 24 hours at 60° C. and stirring at 100 rpm, is less than 1,000 mPa·s, preferably less than 800 mPa·s, more preferentially less than 500 mPa·s or less than 400 mPa·s.

Preferably, suspension S uses a single material M or two or three materials M. More preferably, suspension S uses a single material M. According to the invention, material M is synthetic or of natural origin. Preferably, material M is chosen among alkaline-earth metal carbonate, more preferentially calcium carbonate (natural calcium carbonate or precipitated calcium carbonate), strontium carbonate, magnesium carbonate, barium carbonate, dolomite, kaolin, titanium dioxide, talc, lime, calcium sulphate, barium sulphate. Preferably, material M is chosen among natural calcium carbonate, precipitated calcium carbonate, magnesium carbonate, dolomite, kaolin, titanium dioxide, talc, lime.

Preferably according to the invention, the solids content of suspension S is greater than 60% by weight, preferably greater than 70% by weight or greater than 75% by weight. Also preferably according to the invention, the solids content of suspension S is comprised between 60% by weight and 80% by weight, preferably between 70% by weight and 80% by weight or between 75% by weight and 80% by weight. The solids content of the suspension is measured by weighing an amount of 100 g of suspension from which the water and the volatile substances at room temperature are separated, for example by heating.

Essentially according to the invention, suspension S is prepared in the presence of an aqueous dispersion that comprises the α-sulphonated polymer P. Preferably according to the invention, polymer P is chosen among an α-ω-disulphonated polymer P1, an α-monosulphonated polymer P2 and combinations thereof.

Preferably according to the invention, polymer P is used in an amount by dry weight ranging from 0.02% by weight to 5% by weight, preferably from 0.05% by weight to 2% by weight, more preferentially from 0.1% by weight to 1.5% by weight relative to the amount by dry weight of mineral material M.

According to the invention, polymer P is prepared using monomer A. Preferably, monomer A is chosen among acrylic acid, an acrylic acid salt and combinations thereof. Advantageously, monomer A can be combined with at least one other monomer chosen among vinyl acetate, methyl acrylate, ethyl acrylate, hydroxyethylmethacrylate, hydroxyethylacrylate, hydroxy propylmethacry late, hydroxypropylacry late, 2-acrylamido-2-methylpropane sulphonic acid (AMPS), maleic acid, maleic anhydride, itaconic acid and combinations thereof. More advantageously, monomer A is chosen among acrylic acid, an acid salt and combinations thereof, combined with at least one other monomer chosen among vinyl acetate, methyl acrylate, ethyl acrylate, hydroxyethylmethacrylate, hydroxyethylacrylate, hydroxy propylmethacry late, hydroxypropylacry late, 2-acrylamido-2-methylpropane sulphonic acid (AMPS), maleic acid, maleic anhydride, itaconic acid and combinations thereof. Much more advantageously, monomer A can be combined with another monomer that is different from maleic acid and maleic anhydride.

Essentially according to the invention, polymer P is prepared in the presence of at least one compound T comprising sulphur IV. Preferably, the compound T is chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, the compound T is a mono-hydrogen sulphite. Sodium hydrogen sulphite or sodium bisulphite is more particularly preferred.

Preferably according to the invention, the polymerisation reaction is carried out at a temperature above 30° C. and below 100° C., preferably below 90° C., more preferentially below 80° C. or below 75° C.

According to the invention, polymer A is prepared in the presence of at least one initiator compound. Preferably, the initiator compound is chosen among a peroxide (for example hydrogen peroxide, tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof.

Essentially according to the invention, polymer P is partially or completely neutralised by means of a monovalent ion. According to the invention, the carboxyl groups of polymer P can be partially neutralised at a rate of 70 to 97 mol %, preferably at a rate of 90 to 95 mol %. Preferably, polymer P is partially non-neutralised. Also preferably, polymer P is completely neutralised.

Preferably according to the invention, the monovalent ion is chosen among K⁺, Na⁺, Li⁺, NH₄⁺ and combinations thereof. The particularly preferred ion is Nat. According to the invention, polymer P can be neutralised by means of at least one compound chosen among NaOH, KOH, LiOH and ammonium derivatives.

Preferably, polymer P has a weight-average molecular mass Mw (measured by SEC) of less than 20,000 g/mol, preferably less than 15,000 g/mol, less than 10,000 g/mol, more preferentially less than 7,000 g/mol or less than 6,000 g/mol. Polymer P generally has a weight-average molecular mass Mw (measured by SEC) greater than 1,000 g/mol or greater than 1,200 g/mol.

Preferably, polymer P has a polymolecularity index PI (measured by SEC) of less than 4 or ranging from 1.2 to 4 or from 1.5 to 4; from 1.2 to 3 or from 1.5 to 3; from 1.2 to 2.5 or even from 1.5 to 2.5.

According to the invention, the molecular weight or mass of polymer P is determined by Size Exclusion Chromatography (SEC). A test portion of the polymer dispersion corresponding to 90 mg of dry solids content is placed in a 10 mL flask. Mobile phase is added, together with 0.04% dimethylformamide (DMF), until a total mass of 10 g is reached. The composition of this mobile phase is as follows: NaHCO₃: 0.05 mol/L, NaNO₃: 0.1 mol/L, triethanolamine: 0.02 mol/L, NaN₃: 0.03% by mass. The SEC chain is composed of a Waters 510 isocratic pump with a flow rate set to 0.8 mL/min, a Waters 717+sample changer, an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standard Service with a molecular weight at the top of the peak comprised between 900 and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using PSS WinGPC Scientific software v 4.02. The chromatogram obtained is incorporated into the zone corresponding to molecular weights of more than 250 g/mol.

Preferably according to the invention, the molar amount of sulphur compound T within suspension S, preferably the molar amount of sulphur IV, is comprised between 1% and 15%, preferably between 1.5% and 12%, relative to the total molar amount of monomers used. More preferably according to the invention, the molar amount of sulphur compound T within suspension S, preferably the molar amount of sulphur IV, is comprised between 1% and 15%, preferably between 1.5% and 12%, relative to the total molar amount of unsaturated groups in the monomers used.

According to the invention, suspension S comprises at least one compound B chosen among a sulpho-carboxylic acid, a sulpho-carboxylic acid salt and combinations thereof. According to the invention, compound B is chosen among sulpho-carboxy-aromatic acids and sulpho-carboxy-alkyl acids, particularly 3-sulphopropionic acid, 3-sulpho-2-methyl-propionic acid, sulpho-succinic acid, their salts and combinations thereof. The salts of compound B are generally sodium salt, potassium salt, lithium salt, calcium salt, magnesium salt or ammonium salt. Preferably, the salts of compound B are sodium salt, potassium salt, lithium salt or ammonium salt.

Essentially according to the invention, the molar amount of compound B present within suspension S is less than 25% relative to the molar amount of sulphur IV. Preferably, the molar amount of compound B present within suspension S is less than 20% or more preferentially less than 15% or less than 12% relative to the molar amount of sulphur IV. Generally according to the invention, the molar amount of compound B present within suspension S is greater than 0.2% relative to the molar amount of sulphur IV. In particular, the molar amount of compound B is greater than 2% or greater than 5% relative to the molar amount of sulphur IV. According to the invention, the molar amount of compound B present within suspension S relative to the molar amount of sulphur IV is therefore generally comprised within the ranges of from 0.2% to 25%, from 2% to 25%, from 5% to 25%, from 0.2% to 20%, from 2% to 20%, from 5% to 20%, from 0.2% to 15%, from 2% to 15%, from 5% to 15%, from 0.2% to 12%, from 2% to 12%, from 5% to 12%.

According to the invention, polymer P is prepared in the absence of any phosphorus compound. In particular, polymer P is prepared in the absence of any compound comprising phosphorus in oxidation state I, in particular in the absence of hypophosphorous acid, sodium hypophosphite, potassium hypophosphite, lithium hypophosphite, ammonium hypophosphite, calcium hypophosphite and magnesium hypophosphite: or in the absence of any compound comprising phosphorus in oxidation state III, in particular in the absence of phosphorous acid and phosphorous acid salt.

The invention also relates to the preparation of suspension S.

Thus, the invention provides a method for preparing an aqueous suspension S comprising the dispersion, optionally the grinding, in water of at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of at least one monovalent ion,
b) at least one compound B chosen among a sulpho-carboxylic acid, a sulpho-carboxylic acid salt and combinations thereof, present in a molar amount of less than 25% relative to the molar amount of sulphur IV.

The preparation of suspension S according to the invention uses the aqueous dispersion of the α-sulphonated polymer P as an agent for dispersing or grinding the mineral material M. The invention also relates to this agent.

Thus, the invention provides a dispersion or grinding agent comprising an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of at least one monovalent ion,
b) at least one compound B chosen among a sulpho-carboxylic acid, a sulpho-carboxylic acid salt and combinations thereof, present in a molar amount of less than 25% relative to the molar amount of sulphur IV.

This agent makes it possible to improve the dispersion or grinding of mineral material M in a particularly effective manner. Thus, the invention also provides a method for improving the efficacy of the dispersion or grinding in water of at least one mineral material M comprising the use, during the dispersion, respectively the grinding, of an aqueous dispersion comprising at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and at least one sulphur compound T comprising sulphur in oxidation state IV, and completely or partially neutralised solely by means of at least one monovalent ion, with a reduced level of compound B chosen among a sulpho-carboxylic acid, a sulpho-carboxylic acid salt and combinations thereof, preferably comprising compound B in a molar amount of less than 25% relative to the molar amount of sulphur IV.

The aqueous suspension S obtained from the invention has particularly advantageous properties and can be used in many technical fields, in particular for paper preparation.

Thus, the invention provides a method for preparing a mass filler composition for papermaking or a paper coating colour composition comprising the preparation of an aqueous suspension S of mineral particles prepared by dispersing, optionally grinding, in water at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of at least one monovalent ion,
b) at least one compound B chosen among a sulpho-carboxylic acid, a sulpho-carboxylic acid salt and combinations thereof, present in a molar amount of less than 25% relative to the molar amount of sulphur IV.

This method for preparing paper comprises the use of a suspension S according to the invention.

The aqueous suspension S obtained through the invention can also be used to prepare a coating composition, in particular a varnish or a paint.

Thus, the invention provides a method for preparing a coating composition comprising:
the preparation of an aqueous suspension S of mineral particles prepared by wet-grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV,
mixing suspension S with at least one binder compound, optionally with at least one rheology modifying compound and optionally with at least one organic or mineral pigment.

The coating composition according to the invention comprises:
an aqueous suspension S of mineral particles prepared by wet-grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV,
at least one binder compound, optionally at least one rheology modifying compound and optionally at least one organic or mineral pigment.

The invention also provides a method for preparing a coating comprising applying a coating composition according to the invention to a substrate.

According to the invention, the particular, advantageous or preferred characteristics of the suspension S according to the invention define methods for its preparation, methods which use it as well as dispersing or grinding agents which are also particular, advantageous or preferred. The following examples illustrate the various aspects of the invention.

### EXAMPLES

### Preparation and Characterisation of Polymers P According to the Invention

### Preparation of Polymer PI According to the Invention

In a 1 litre glass reactor equipped with a stirrer, a thermometer and a cooling system, a load comprising 0.006 g of iron sulphate heptahydrate and 380 g of water is prepared at room temperature. While the temperature is rising, 3 loads to be introduced in parallel over 3 hours are prepared. In a first beaker 623.5 g of acrylic acid is introduced, in a second beaker 5.086 g of sodium persulphate and 46.6 g of water are introduced, and in a third beaker 122.86 g of a 40% by mass aqueous sodium bisulphite solution is introduced. After 3 hours of addition at 73° C., a clear dispersion of polymer PI is obtained. This polymer is then completely neutralised by adding sodium hydroxide (pH=8.3). The concentration of dry solids content is 40.2%. Polymer PI has an Mw of 4,430 g/mol and a PI of 2.2.

### Preparation of Polymer P2 According to the Invention

In a 1 litre glass reactor equipped with a stirrer, a thermometer and a cooling system, a load comprising 0.006 g of iron sulphate heptahydrate and 380 g of water is prepared at room temperature. While the temperature is rising, 3 loads to be introduced in parallel over 3 hours are prepared. In a first beaker 623.5 g of acrylic acid is introduced, in a second beaker 4.0688 g of sodium persulphate and 46.6 g of water are introduced, and in a third beaker 98.288 g of a 40% by mass aqueous sodium bisulphite solution is introduced. After 3 hours of addition at 73° C., a clear dispersion of polymer P2 is obtained. This polymer is then completely neutralised by adding sodium hydroxide (pH=8.2). The concentration of dry solids content is 41.0%. Polymer P2 has an Mw of 5,890 g/mol and a PI of 2.3.

### Preparation of Polymer P3 According to the Invention

In a 1 litre glass reactor equipped with a stirrer, a thermometer and a cooling system, a load comprising 0.006 g of iron sulphate heptahydrate and 380 g of water is prepared at room temperature. While the temperature is rising, 3 loads to be introduced in parallel over 3 hours are prepared. In a first beaker 623.5 g of acrylic acid is introduced, in a second beaker 4.577 g of sodium persulphate and 46.6 g of water are introduced, and in a third beaker 110.57 g of a 40% by mass aqueous sodium bisulphite solution is introduced. After 3 hours of addition at 73° C., a clear dispersion of polymer P3 is obtained. This polymer is then completely neutralised by adding sodium hydroxide (pH=8.5). The concentration of dry solids content is 47.6%. Polymer P3 has an Mw of 4,805 g/mol and a PI of 2.2.

### Preparation of Polymer P4 According to the Invention

In a 1 litre glass reactor equipped with a stirrer, a thermometer and a cooling system, a load comprising 0.006 g of iron sulphate heptahydrate and 380 g of water is prepared at room temperature. While the temperature is rising, 3 loads to be introduced in parallel over 3 hours are prepared. In a first beaker 623.5 g of acrylic acid is introduced, in a second beaker 5.341 g of sodium persulphate and 46.6 g of water are introduced, and in a third beaker 129.005 g of a 40% by mass aqueous sodium bisulphite solution is introduced. After 3 hours of addition at 73° C., a clear dispersion of polymer P4 is obtained. This polymer is then completely neutralised by adding sodium hydroxide (pH=8.3). The concentration of dry solids content is 48.1%. Polymer P4 has an Mw of 4,285 g/mol and a PI of 2.2.

Compound B and the amount of compound B (mol % relative to the molar amount of sulphur IV of the compound T used) contained in each polymer dispersion are determined by sulphate ion assay and by 1H NMR and 13C NMR analysis of the sulphonated groups of polymer P and of compound B.

The sulphate ion levels in the polymer dispersions are determined by ion chromatography. A test portion of about 80 mg of polymer dispersion is introduced into a 15 mL vial. Mobile phase is added to a total mass of 15 g. The composition of the mobile phase is as follows: sodium carbonate: 0.009 mol/L. The ion chromatography chain for the anion assay consists of a Dionex Aquion ion chromatography system with built-in degasser, of which the flow rate is set at 1 mL/min, containing a chemical suppressor, an AG9-HC precolumn, a CG3 metal trap precolumn, an NG1 precolumn and an AG9-HC column. A conductimetric detector is used for detection. The ion chromatography instrument is calibrated with a series of sodium sulphate solution standards. The calibration range is comprised between 0.5 and 100 ppm. The calibration curve is straight-line. The instrument automatically dilutes the samples to ensure that they are within the calibration range. Acquisition and processing of the chromatogram are performed using Chromeleon software 7.2.10.

¹H NMR and ¹³C NMR analyses are carried out using a Bruker AV III HD 500 spectrometer equipped with a 5 mm BBI probe. The polymer samples were dissolved in deuterated water and examined by ¹H NMR and ¹³C NMR using 2D experiments: correlations ¹H/¹³C at ordinary distance and at long distance.

The dispersions of polymers P1 to P4 according to the invention comprise 3-sulphopropionic acid as compound B. The results are shown in Table 1.

TABLE 1

| Polymer | P1 | P2 | P3 | P4 |
|---|---|---|---|---|
| Compound B (%) | 10.2 | 10.2 | 9.7 | 10.2 |

### Preparation and Characterisation of Aqueous Suspensions S According to the Invention

Using a peristaltic pump, a mineral suspension (calcium carbonate BL 200-Omya) is prepared in the presence of a polymer P according to the invention using a grinder (Dyno Mill type KDL pilot 1.4 L) containing 2,750 g of ceramic beads (ER 120 S from 0.6 mm to 1.0 mm in diameter—Saint Gobain).

The grinding conditions are adjusted so as to obtain a suspension of particles of mineral material of the desired particle size distribution. The concentration of the ground suspension is 76%+/−1%. The amount of polymer introduced into the system is 0.65% by weight (dry polymer/dry calcium carbonate) in order to achieve the desired particle size distribution (90%+/−2% of particles <2 μm). This suspension is then characterised by a particle size measurement, by a Brookfield viscosity measurement (10 rpm and 100 rpm) and by a stability test. The stability test consists of measuring the Brookfield viscosity of the ground suspension after a rest time of 24 hours at a temperature of 60° C.+/−2° C., before stirring (at 100 rpm) and after stirring (at 10 rpm and 100 rpm).

The particle size characteristics are determined using a SediGraph III5120 instrument (Micromeritics, USA). The particle size distribution of the suspensions of particles of mineral material is measured by determining the mass fraction in percentage of a population of particles with an equivalent spherical diameter of less than 1 μm or even less than 2 μm (esd <1 μm or esd <2 μm, expressed in %). These measurements are carried out for an aqueous suspension of particles of mineral material diluted to a concentration of approximately 33 g of dry solids content per litre of solution and comprising an aqueous dispersion of polymer P at a concentration of 1.6 g of dry polymer. Each sample is dispersed and sonicated prior to measuring.

The Brookfield viscosities at 10 rpm and 100 rpm (mPa·s) of aqueous suspensions of particles of mineral material are measured at 25° C.+/−2° C. after grinding (VB0) and after 24 hours of rest (at 60° C.+/−2° C.) (VB24) then after 24 hours and after stirring (VB24a), using a Brookfield DVIII viscometer equipped with a suitable module 2 to 5. The polymers used and the results obtained are shown in Table 2.

TABLE 2

| Polymer | P1 | P2 | P3 |
|---|---|---|---|
| esd < 1 μm (%) | 62 | 61 | 64 |
| esd < 2 μm (%) | 92 | 92 | 91 |
| VB0 10 rpm | 650 | 540 | 710 |
| VB0 100 rpm | 271 | 215 | 279 |
| VB24 100 rpm | 1,042 | 1,060 | 1,548 |
| VB24a 10 rpm | 470 | 610 | 890 |
| VB24a 100 rpm | 234 | 256 | 353 |

The use of a polymer P according to the invention comprising a controlled amount of compound B makes it possible to effectively control the particle size of the suspension as well as its viscosity and its stability.

1. An aqueous suspension S of mineral particles, comprising
water;
at least one mineral material M;
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV (sulphur IV or S IV), and completely or partially neutralised solely by means of at least one monovalent ion, and
at least one compound B selected from a sulpho-carboxylic acid, a sulpho-carboxylic acid salt, and a combination thereof, present in a molar amount of less than 25% relative to the molar amount of sulphur IV.

2. The suspension S according to claim 1:
wherein the particles of dispersed material M have a size of less than 50 μm, or
wherein material M is wet-ground in the presence of the aqueous dispersion, to produce particles of ground material M having a size of less than 50 μm, or
wherein the particles of dispersed material M have a Brookfield viscosity, measured after preparation and at 100 rpm and 25° C., is less than 1,000 mPa·s, or
wherein the particles of dispersed material M have a Brookfield viscosity, measured at 100 rpm at 25° C. after resting for 24 hours at 60° C. and stirring at 100 rpm, is less than 1,000 mPa·s.

3. The suspension S according to claim 1, in which wherein:
the aqueous suspension comprises one to three materialsM; or
the material M is synthetic or of natural origin or
the aqueous suspension has a solids content is greater than 60% by weight.

4. The suspension S according to claim 1, in which polymer P is selected from an α-ω-disulphonated polymer PI, an α-monosulphonated polymer P2, and a combination thereof.

5. The suspension S according to claim 1,
wherein monomer A is selected from acrylic acid, an acrylic acid salt, and combinations a combination thereof, or
wherein monomer A is combined with at least one other monomer selected from vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid, and a combination thereof, or
wherein monomer A is selected from acrylic acid, an acid salt, and a combination thereof, and is combined with at least one other monomer selected from vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid, and a combination thereof, or
wherein the compound T is selected from lithium hydrogen sulphite, sodium hydrogen sulphite, potassium hydrogen sulphite, ammonium hydrogen sulphite, calcium di(hydrogen sulphite), magnesium di(hydrogen sulphite), and a combination thereof, or
wherein the polymerisation reaction is carried out at a temperature above 30° C. and below: 100° C., or
wherein polymer A is prepared in the presence of at least one initiator compound selected from a peroxide, a persulphate, a combination thereof, and associations thereof with a metal salt, or
wherein polymer P is completely or partially non-neutralised, or
wherein polymer P is completely or partially neutralised by means of a monovalent ion chosen among K⁺, Na⁺, Li⁺, NH₄⁺, and a combination thereof, or
wherein polymer P has a weight average molecular mass MW (measured by SEC) less than 20,000 g/mol, or
wherein polymer P has a weight-average molecular mass Mw (measured by SEC) greater than 1,000 g/mol, or
wherein polymer P is present in an amount by dry weight ranging from 0.02% by weight to 5% by weight, relative to the amount by dry weight of mineral material M.

6. The suspension S according to claim 1:
wherein the sulphur compound T is present in an amount of 1% and 15% relative to the total molar amount of monomers used.

7. The suspension S according to claim 1, wherein compound B is selected from a sulpho-carboxy-aromatic acid, a sulpho-carboxy-alkyl acid, a combination thereof, and a salt thereof.

8. The suspension S according to claim 1:
wherein the compound B is present within suspension S in an amount of less than 20%, relative to the molar amount of sulphur IV, or
wherein the compound B is present within suspension S in an amount of greater than 0.2%, relative to the molar amount of sulphur IV.

9. A method for preparing an aqueous suspension S according to claim 1, the method comprising
dispersing in water at least one mineral material M in the presence of an aqueous dispersion comprising:
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV, and completely or partially neutralised solely by means of at least one monovalent ion,
at least one compound B selected from a sulpho-carboxylic acid, a sulpho-carboxylic acid salt, and a combination thereof, present in a molar amount of less than 25% relative to the molar amount of sulphur IV.

10. A dispersion or grinding agent comprising an aqueous dispersion comprising:
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV, and completely or partially neutralised solely by means of at least one monovalent ion, and
at least one compound B selected from a sulpho-carboxylic acid, a sulpho-carboxylic acid salt, and a combination thereof, present in a molar amount of less than 25% relative to the molar amount of sulphur IV.

11. A method for improving the efficacy of the dispersion or grinding in water of at least one mineral material M, the method comprising during the dispersing or grinding, adding to the water an aqueous dispersion comprising
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV, and completely or partially neutralised solely by means of at least one monovalent ion, and
a compound B selected from a sulpho-carboxylic acid, a sulpho-carboxylic acid salt, and a combination thereof.

12. A method for preparing a mass filler composition for papermaking or a paper coating colour composition, the method comprising
preparing an aqueous suspension S of mineral particles prepared by dispersing, and optionally grinding, in water at least one mineral material M in the presence of an aqueous dispersion comprising:
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV, and completely or partially neutralised solely by means of at least one monovalent ion, and
at least one compound B selected from a sulpho-carboxylic acid, a sulpho-carboxylic acid salt, and a combination thereof, present in a molar amount of less than 25% relative to the molar amount of sulphur IV.

13. A method for preparing paper comprising a suspension S according to claim 1.

14. A method for preparing a coating composition, the method comprising:
preparing an aqueous suspension S of mineral particles by wet-grinding at least one mineral material M in the presence of an aqueous dispersion comprising:
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV, and completely or partially neutralised by means of a combination of at least one monovalent ion and of at least one divalent ion, and
at least one compound B selected from a sulpho-carboxylic acid, a sulpho-carboxylic acid salt, and a combination thereof, present in a molar amount of less than 25% relative to the molar amount of sulphur IV, and
mixing suspension S with at least one binder compound.

15. A coating composition comprising:
an aqueous suspension S of mineral particles comprising at least one mineral material M, and
an aqueous dispersion comprising:
at least one α-sulphonated polymer P prepared in water and in the absence of any phosphorus compound, by a polymerisation reaction of at least one monomer A selected from acrylic acid, methacrylic acid, an acrylic acid salt, a methacrylic acid salt, and a combination thereof, in the presence of at least one initiator compound and of at least one sulphur compound T comprising sulphur in oxidation state IV, and completely or partially neutralised by means of a combination of at least one monovalent ion and of at least one divalent ion, and
at least one compound B selected from a sulpho-carboxylic acid, a sulpho-carboxylic acid salt, and a combination thereof, present in a molar amount of less than 25% relative to the molar amount of sulphur IV, and
at least one binder compound.

16. A method for preparing a coating comprising applying a coating composition according to claim 15 to a substrate.
